(19) United States
(12) Patent Application Publication
(10) Pub. No.: US 2010/0191590 A1
(43) Pub. Date: Jul. 29, 2010

(54) METHOD FOR ESTABLISHING A CONTROLLED DATA TRANSFER CONNECTION BETWEEN TWO SYSTEMS

(75) Inventors: Harri Hakkarainen, Porvoo (FI); Juha Utriainen, Espoo (FI)

Correspondence Address: YOUNG & THOMPSON, 209 Madison Street, Suite 500, Alexandria, VA, 22314, US

(73) Assignee: HUUKED LABS OY, Vantaa (FI)

(21) Appl. No.: 12/601,546

(22) PCT Filed: May 26, 2008
(86) PCT No.: PCT/FI2008/050303

§ 371 Date: Nov. 24, 2009

(30) Foreign Application Priority Data
May 24, 2007 (FI) 20070406

(51) Int. Cl. G06Q 30/00; G06Q 20/00; G06F 17/30; G06F 15/16; H04L 9/00; G06Q 50/00

(52) U.S. Cl. 705/14.23; 705/14.51; 705/27; 705/34; 705/44; 707/741; 709/217; 713/150; 707/E17.083

(57) ABSTRACT

Method for creating a controlled data transfer connection between a remote device and a subscriber terminal by a transmission system. The first party of the interconnection, (remote device), creates a connection to the transmission system, which verifies information used for the authentication informed by the remote device and allocates an unique identifier ID for the remote device, by which the remote device can be addressed in the transmission system. The other part of the interconnection, (subscriber terminal), requests the transmission system to transmit the request to the remote device, identified by the identifier. The transmission system transmits this request to the remote device, which processes the request and sends the response via the transmission system to the subscriber terminal. This response can be converted in the transmission system to a form suitable for the subscriber terminal, and subscriber-targeted advertisements, or other data, may be added in the response.

### FIELD OF THE INVENTION

This invention relates to a method for creating a controlled data transfer connection between two systems.

### BACKGROUND OF THE INVENTION

Establishing a data transfer connection between two systems can be technically very difficult as the divergence of devices has led to a situation where the users have more and more differing devices that may be connected to various access networks. An access network may include a cellular radio access network such as a GPRS (General Packet Radio Service) network, a wireless local area network (WLAN), or a wired connection. Usually, the access networks have a connection with a service network, which is typically an IP network (Internet Protocol) such as Internet or closed subnets (intranet, extranet, etc.). Naturally, these networks are merely illustrative, non-limiting examples.

Usually, the device connected to the access network is protected with a firewall located in the service network, or with software executed in the device such that the connections directed from the access or service network are prohibited or limited.

In somewhat typical case, upon creating a data transfer connection between two devices, the following problems may appear:
the device, which initiates establishing a connection, has to be aware of how to point the target device in the access or service network (e.g. IP address),
the firewall or the other security system of the target device has to be configured to allow the creation of the connection,
the networks may apply different technologies to translate addresses such as NAT (Network Address Translation), which makes the pointing of the target device difficult.

The physical size of devices that are becoming smaller, the increasing processing power, and developments in the battery technology as well as the arising ability to log in to different access networks has increased the mobility of the devices and converged various features thereof. For example, certain digital cameras support wireless network connections (WLAN), a WWW browser (World Wide Web), and respectively, more and more mobile phones incorporate an integrated digital camera.

The digital content of users such as photos, music, software and other files have increased the need for easy access to the content in another device without particularly knowing the access and service networks used by the devices and their technical features such as different addresses, ports and limitations.

Generally, it can be said that the remote administration and transfer of digital content from a device to another is technically difficult even to those skilled in the art.

### SUMMARY OF THE INVENTION

The objective of the present invention is to develop a method and a system for implementing the method so as to at least alleviate the problem described above. The objective is met by a method and a system characterized in that what is stated in the independent method and system claims of this document, respectively. Various preferred embodiments of the present invention are set forth in the dependent claims.

In one aspect of the present invention, a method is provided for data transfer between a subscriber terminal and a remote device such that the resources of the remote device may be managed via an Internet browser, which may be based on the HTTP protocol (Hypertext Transfer Protocol), for example. However, the present invention is not solely limited to the use of this particular or any other protocol. In the method, establishment of the connection and data transfer between the subscriber terminal and the remote device is controlled by further equipment, i.e. a transmission system. The creation of the connection and the data transfer may comprise steps wherein:
the remote device creates a connection to the transmission system and presents the information needed for the authentication (for example, a user name and password) thereto,
the transmission system allocates a unique identifier to the remote device, via which the remote device can be addressed in the transmission system,
the subscriber terminal sends a request to the transmission system, which is directed to the remote device addressed with a certain identifier.
the transmission system transmits the aforesaid request to the remote device identified by the identifier,
the remote device receives the request, verifies the authorization of the subscriber terminal to the requested resource and delivers the response directed to the subscriber terminal, and
the transmission system delivers the response to the subscriber terminal.

In accordance with a preferred embodiment of the present invention a web address (URL; Uniform Resource Locator) may be exploited for referring to the remote device and shared resources thereof via the utilization of e.g. the HTTP protocol. Such approach enables managing the remote device via a stand-alone Internet browser advantageously without any additional software, and enables indexing the remote devices by Internet (web) search engines. Thereby the remote devices and shared resources thereof may be found on the basis of searches capitalizing the Internet search engines.

In another aspect of the present invention, a transmission system for enabling the data transfer between the subscriber terminal and the remote device is provided. The transmission system comprises control logic to control the establishment of the data transfer connection between the subscriber terminal and the remote device. The control logic comprises a first logic to define the communications node used for the remote device, and a second logic to deliver the request sent by the subscriber terminal to the desired remote device. The system further advantageously comprises, e.g. in connection with the first logic, providing the remote device with a unique URL (Uniform Resource Locator) to enable addressing the remote device in the transmission system by the subscriber terminal via an Internet browser. The system may further comprise a third logic to present the response of the remote device in a suitable form for the subscriber terminal. The different logics may be generally implemented via one or more software entities, hardware entities, or a combination thereof.

In another additional aspect, the control logic comprises a fourth logic to produce charging information related to the transferred data and enters it as income to the registered user represented by the remote device.

In one preferred embodiment, both the remote device and the subscriber terminal are connected to the access network. The transmission system may be located either in the access or the service network. If the transmission system is located in the service network, the access networks of both the remote device and the subscriber terminal have a connection to that particular service network.

In another preferred embodiment, the transmission system indexes the shared resources of the remote devices connected to it and provides a search function, which can be used to search for the resources with different conditions.

In a further preferred embodiment, both the remote device and the transmission system may convert the data delivered to the subscriber terminal, for example, according to the information informed by the subscriber terminal, settings of the transmission system, or settings of a potentially used user account.

In a further preferred embodiment, the transmission system maintains information of the users that are registered therewith, which includes an account for virtual money, for instance. The transmission system can direct different credits and fees to this account, and the subscriber terminal can use the virtual money deposited to the account, if the subscriber terminal has been authenticated to the aforementioned user. According to another additional aspect, the systems enables exchanging virtual money into real currency, goods or a refund in a manner that may be agreed separately, e.g. case-specifically.

In another preferred embodiment, the transmission system may produce charging information about data that the remote system has marked as chargeable. If so, the charging information may be included in the delivered response by the remote party, after which the transmission system requests the confirmation of the payment event. After the subscriber terminal has confirmed its approval to pay for the event, the desired data is delivered to the subscriber terminal such that the components on the basis of which the operator, service provider, or a similar quarter is able to charge for the event, will be added to the transferred data. Concerning this charge, a portion can be entered as income or be compensated as virtual money to the user's account relative to which the remote device, from the resources offered by which the charge is created, has authenticated itself when establishing the connection.

In another preferred embodiment, the transmission system is configured to profile the subscriber terminal on the basis of the information given by the terminal itself and the address information, and to subsequently deliver focused advertisements in connection with the response. According to a further preferred feature, from the income provided by the advertisements at least a part can be deposited as virtual money to the account of the user relative to which the remote device, alongside the response of which the advertisements are presented, has authenticated itself upon establishing the connection.

Further in another preferred embodiment, the transmission system may comprise several distributed components that can be geographically separated. The transmission system may itself control the logics and the communication between the components.

Yet in another preferred embodiment, the connections between the transmission system and the remote device as well as the transmission system and the subscriber terminal are encrypted. Optionally, only one of the aforementioned connections is encrypted.

The primary application of the current invention is based on that the data connection between two devices can be created easily regardless of the access networks the devices utilize. With a browser or similar software the subscriber terminal is able to establish a connection to the remote device connected to a desired transmission system by addressing it in the transmission system with an identifier that has been allocated to that particular remote device.

The advantage of the method and the system according to the present invention is that neither the subscriber terminal nor the remote device has to know all the technical characteristics of its own access network and the used service network and the addresses of the remote party in its access network.

According to an aspect of the invention presented above, it is possible to the user to manage the digital content located in the remote device with every Internet browser or a subscriber terminal that has been equipped with similar software regardless of the operating system, location or time.

From the standpoint of the user, the use of the service according to one aspect of the invention is explained, by way of example, as following:

The user executes the browser of the applied mobile phone or subscriber terminal and selects an address that points to the transmission system. For example, this may be http://foo.com.

The transmission system may present a web page to the user's browser, wherein the user is requested to enter an identifier of that remote device to which the connection is advantageously created. Alternatively, such identifier can be presented already in the request, in which case the identifier is not requested separately. This and all the other pages presented to the browser may be used to visualize advertisements or other content that has been selected on the basis of profiling the user or the used subscriber terminal.

The transmission system creates a connection to the desired remote device and may further deliver, to the user's browser, the starting/main page of the remote device, where those digital contents and services that the owner of the remote device has defined as visible are shown.

The user can select from the shown starting page a particular content or service that he/she wants to observe. After the selection the more accurate information about the selected content or service and the functional alternatives of the related content may be delivered to the browser of the subscriber terminal (for example, downloading, accessing/opening, deleting, viewing a picture fitted to the display of the subscriber terminal, etc).

The user may, for example, download music into the subscriber terminal from the above mentioned view of the remote device, look at the digital photographs, which are located in the remote device or store to the remote device the contents, which are located in the subscriber terminal.

In addition to the management of different content, the remote device may enable managing a web camera connected to the computer so that real-time camera picture may be obtained and camera settings managed.

One particularly significant aspect of the present invention comprises functionality whereby a plurality of mobile terminal users may share digital content therebetween. Digital content may be easily retrieved from other users' mobiles and the procedure may even be facilitated by the exploitation of Internet search engines as each remote device is associated with an own URL behind which the shared resources can be found.

The use of the service can be finished by terminating the browser application.

### BRIEF DESCRIPTION OF THE DRAWINGS

Next the invention will be described in more detail, in connection with preferred embodiments, with reference to the following drawings, where:

FIG. 1 illustrates a coarse picture of the functional environment;

FIG. 2 illustrates an example of the internal architecture of the transmission system;

FIG. 3 illustrates signaling while establishing the data transmission connection and during the data transmission itself;

FIG. 4 illustrates the logic through which the remote device connects to the transmission system;

FIG. 5 illustrates the logic that forwards the request of the subscriber terminal to the remote device via the transmission system;

FIG. 6 illustrates the logic with which the data of the response is converted either in the remote device or in the transmission system before its delivery to the subscriber terminal requested for the resource;

FIG. 7 illustrates the logic utilized by the remote device for coding an SMS (short message service) message upon transmission thereof, or for transmitting the message to the transmission system for coding and then sending an already coded message.

### DETAILED DESCRIPTION OF THE EMBODIMENTS

This invention relates to the method, which enables creating of a connection and data transfer between the subscriber terminal and the remote device so that it is possible to control the resources of the remote device with browsers, which are, for the present, based on the HTTP protocol (Hypertext Transfer Protocol). However, the invention is not restricted only for the use of this protocol. The method is based on the utilization of a transmission system, or “delivery system”, that can couple the remote devices connected with it and the subscriber terminals that send requests to the remote devices. The transmission system delivers the requests to the proper remote devices and respectively, transmits the response of the remote device to the subscriber terminal either as is or as converted. The response can be converted with several ways, for example, by adjusting the pictures to fit the display of the subscriber terminal, convert the data from one format to another, adding some other content such as advertisements to the response, or presenting the response in a fully novel way.

The remote device may be any given device in which a program compatible with the transmission system can be executed; the program may have been made specifically for this purpose, or it may have also other functionalities. Any given device that has a browser or software, which has the corresponding functions, can act as a subscriber terminal. In order to both the remote device and the subscriber terminal be able to create the connection to the transmission system, they have to be connected to the access networks and said access networks have to bear a connection to that access or service network, where the transmission system is located.

It is possible to register users to the transmission system, in which case both the remote device and the subscriber terminal can log in the system applying the user's authentication information and thus obtain access to user-specific settings, resources and features.

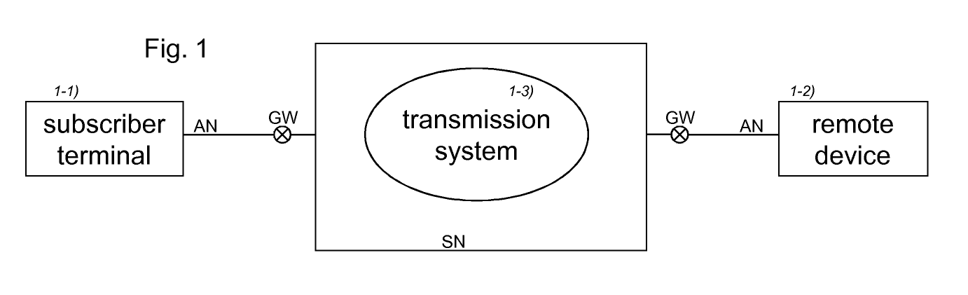

FIG. 1 illustrates a general level block diagram of the system in which the invention can be exploited. The user's terminal station (subscriber terminal; 1-1) has connected to the access network AN, and, via it, to the transmission system (1-3), which may be located in the access network (AN) or service network (SN). Also the remote device (1-2) has connected via the access network to the transmission system described above. The access network can be a cellular radio access network such as the GPRS (General Packet Radio Service) network, third generation (3G) network such as UMTS (Universal Mobile Telecommunications System), local area network (LAN), or e.g. a wireless local area network (WLAN). Usually, the access and the service networks have been mutually coupled with a gateway GW. The service network SN can be an IP network such as Internet or one of its closed subnets such as an intranet or extranet. However, a skilled person will appreciate the fact that these examples of the access and service networks shall not be considered as restrictive.

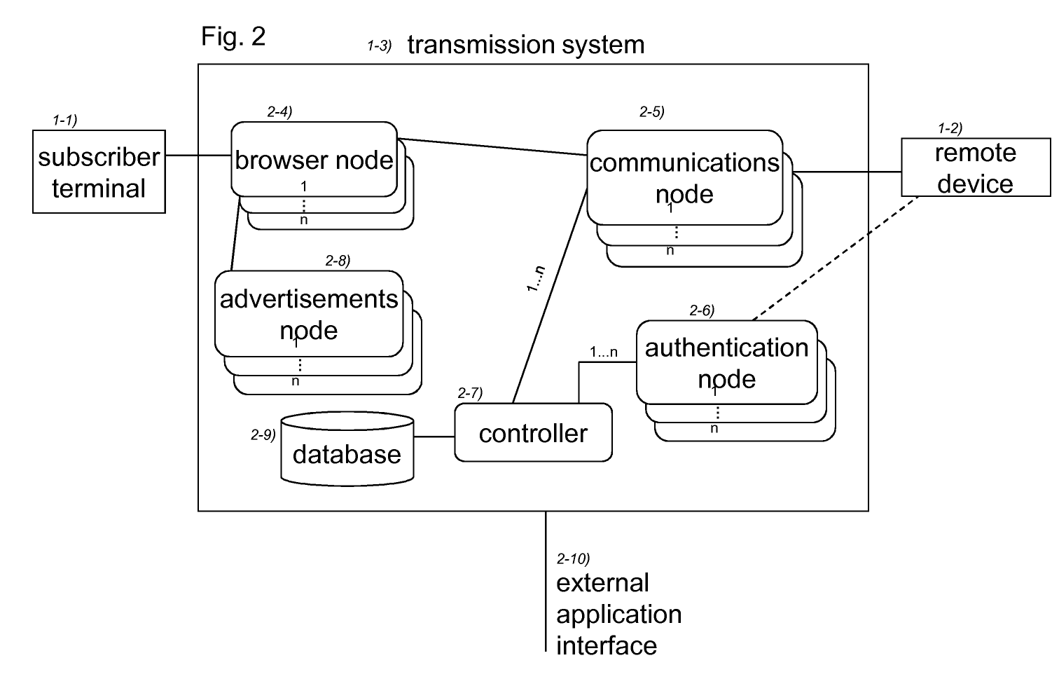

FIG. 2 illustrates a block diagram of one preferred embodiment of the transmission system (1-3). In this example, the transmission system includes six main blocks, i.e. functions: the browser node 2-4, the communications node 2-5, the authentication node 2-6, the advertisements node 2-8, the database 2-9 and the controller 2-7. In addition, the transmission system comprises an interface for external applications 2-10. This interface may be applied by the transmission system for utilizing other external applications, whereby also the external applications may take advantage of the transmission system and the information stored by the system.

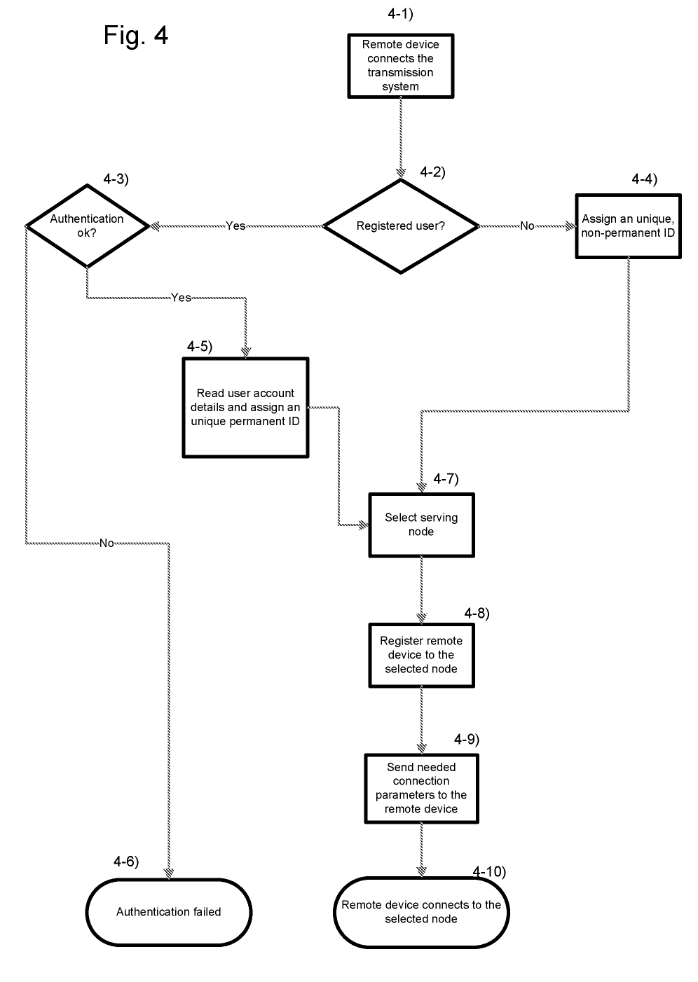

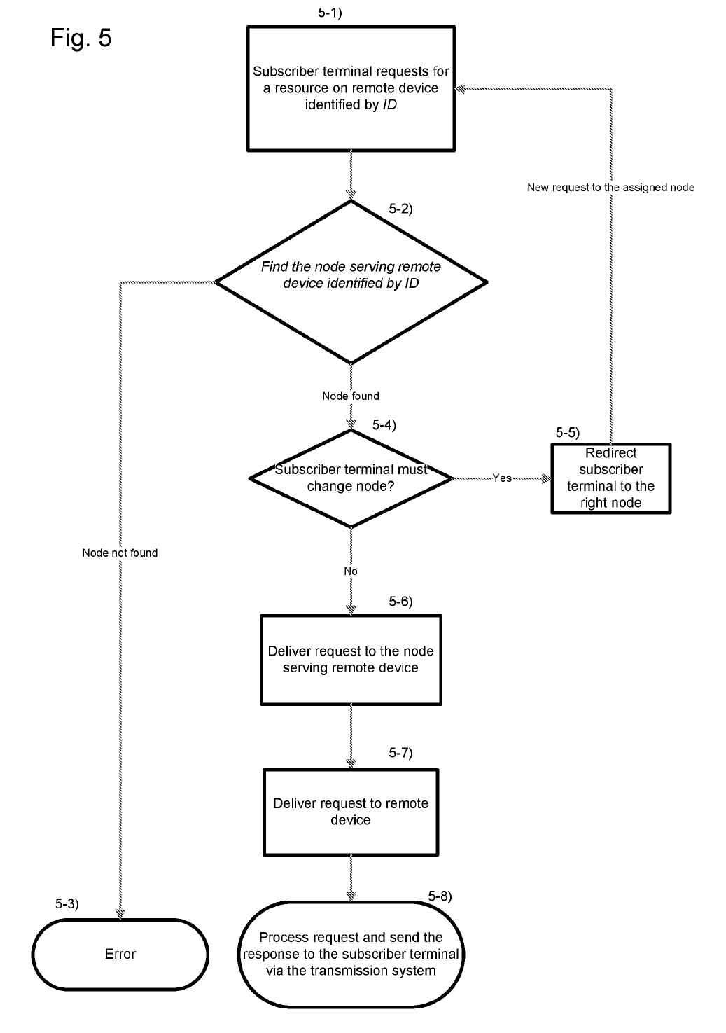

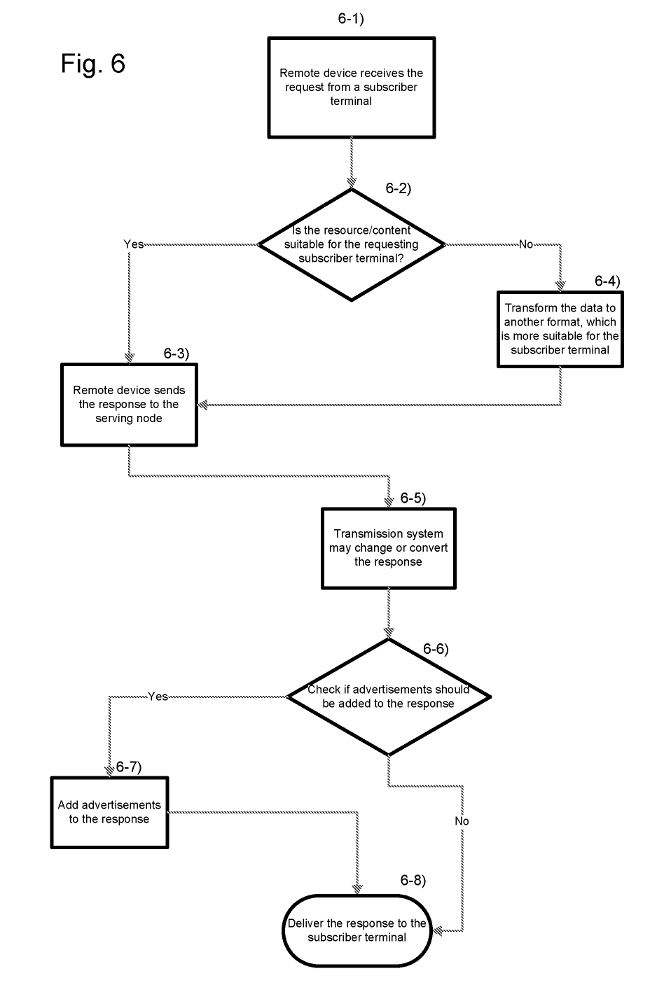

The controller includes the control logic for controlling functions. The control logic may, by way of example only, include three at least logically separable main elements. The first logic (FIG. 4) may be configured to determine the communications node (e.g. desired or otherwise applicable), which shall serve the remote device connected to the transmission system, and take care of associated tasks. The second logic (FIG. 5) may be configured to transmit the request of the subscriber terminal via a proper communications node to the remote device addressed in the request. The third logic (FIG. 6) may be configured to convert the data retrieved from the remote device to a suitable form for the subscriber terminal and to determine the advertisements to be added into the request. When the transmission system has to be scaled (duplicated, for example) because of the amount of active communications, the critical blocks include the browser node, the communications node and the authentication node. Several blocks may share the same controller and database. Also the advertisements node may have to be scaled because of the considerable amount of data traffic.

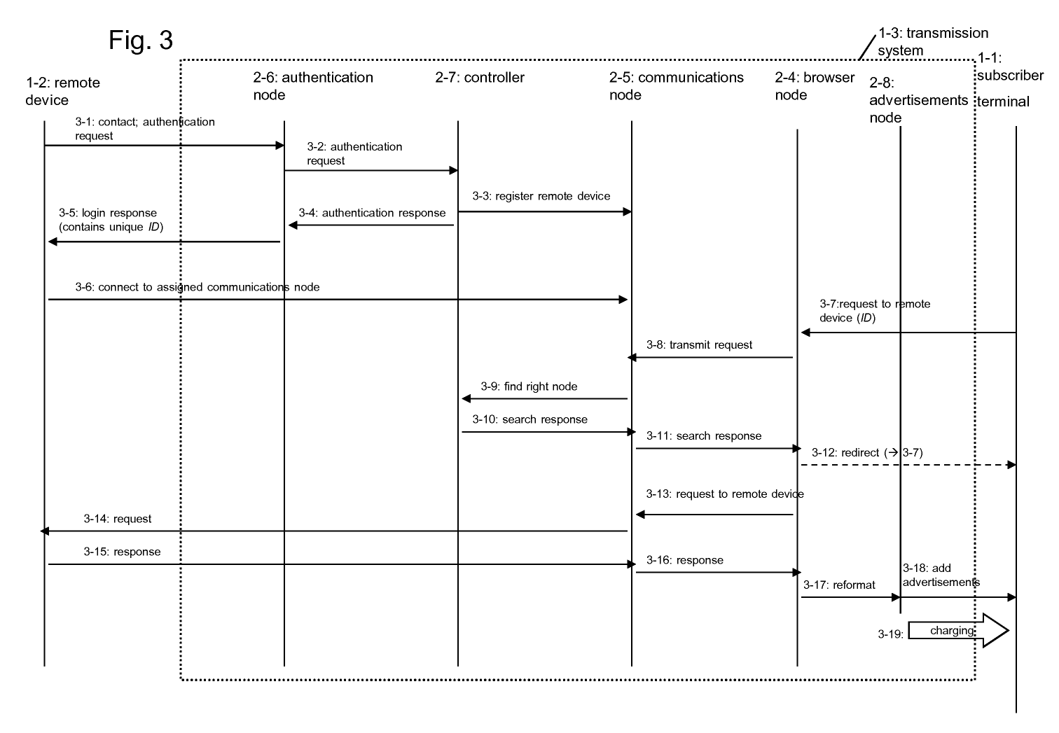

FIG. 3 illustrates steps for creating a data transmission connection and for transferring data, which are explained next: The remote device (1-2) contacts (3-1) the authentication node (2-6) of the transmission system, which transmits the authentication request (3-2) to the controller (2-7). The controller verifies the authentication information and selects the communications node (2-5) for serving the remote device. Subsequently the controller (2-7) registers (3-3) the remote device with a chosen communications node (2-5) and replies (3-4) to the authentication request. In the stage 3-5, the authentication node transmits the response to the remote device. The response includes at least an unique identifier, hereinafter referred to as an ID, allocated to the remote device, and the information of the communications node (2-5) chosen to serve the remote device. At 3-6, the remote device (1-2) creates a connection to the communications node (2-5) that has been identified in the response (3-5). In the stage 3-7, the subscriber terminal (1-1) requests from the transmission system some resource at the remote device (1-2), which can be addressed in the transmission system by the identifier ID. The browser node (2-4) that receives the request (3-7) transmits (3-8) it to a communications node (2-5). In case the remote device (1-2) has connected to a different communications node (2-5), the communications node (2-5) may request (3-9) the controller (2-7) to find the communications node (2-5) whereto the remote device (1-2) addressed with the identifier ID is has connected.

In the stage 3-10, the controller (2-7) replies to this request. At 3-11 the communications node (2-5) transmits the response to the browser node (2-4) that requested it. The response (3-11) may include a request to direct the browser of the subscriber terminal to switch (3-12) to another browser node (2-4) or the response (3-11) may include contact data of the communications node (2-5) that serves the sought after remote device (1-2) addressed with the identifier ID. In the stage 3-13, the browser node (2-4) transmits the request to the chosen communications node (2-5) that passes (3-14) the request to the remote device (1-2) addressed with the identifier ID. In the stage 3-15, the remote device (1-2) delivers the response to the communications node (2-5) requesting it, which transmits (3-16) it forward to the browser node (2-4) in changed form or as is. In the stage 3-17, the browser node (2-4) may change or convert the request delivered to the subscriber terminal (1-1). In the stage 3-18, the response is delivered to the subscriber terminal (1-1) and various advertisements or other corresponding content may be added thereto during the delivery phase. Accordingly, information that can be utilized by external systems for charging (3-19) purposes may be added to the response.

FIG. 4 illustrates a part of the control logic the purpose of which is to define a communication node for serving the remote device that connects to the transmission system. In the stage 4-1, the remote device connects to the transmission system. In the stage 4-2, it is verified, whether the remote device is trying to authenticate as some registered user. If not, in the stage 4-4, a unique, changing/temporary identifier is allocated to the remote device. Otherwise, the transmission system verifies (stage 4-3) the authentication information informed by the remote device. In case the user account to be used cannot be defined on the basis of the authentication information, this is announced via an error message in the stage 4-6. If the user account is found, at 4-5 the settings of the user account are read and a permanent, or “static”, identifier related to the user account is allocated to the remote device. In the stage 4-7, the transmission system selects an applicable node for serving the remote device. This selection may be based e.g. on the information obtained from the remote device, the settings of the system, or the definition(s) of the user account. In the stage 4-8, the transmission system delivers the information of the remote device to the node chosen for serving the remote device. In the stage 4-9, the remote device is advised about new connection parameters that may be used to connect to the node that serves the device. In the stage 4-10, the remote device creates a new connection directly the node serving it.

FIG. 5 illustrates a part of the control logic, the purpose of which is to deliver the request of the subscriber terminal to the node that is serving the remote device identified in the request and which said remote device can be pointed with the identifier ID. In the stage 5-2, the node serving the said remote device is searched. In case the node is not found, it is informed of the error (stage 5-3). If the node is found, in the stage 5-4 it is verified if the subscriber terminal shall preferably be controlled to connect to another node. If that is desired, in the stage 5-5 the subscriber terminal is directed to another node, after which the subscriber terminal returns to stage 5-1 in the new node. If the subscriber terminal shall not be directed to another node, in the stage 5-6 the request of the subscriber terminal is transmitted to the node serving the remote device. In the stage 5-7, the node serving the remote device transmits the request to the remote device. In the stage 5-8, the remote device replies to the request that is delivered to the subscriber terminal via the transmission system.

FIG. 6 illustrates a part of the control logic the purpose of which is to convert or transform data delivered by the remote device to a form suitable for the subscriber terminal. In the stage 6-1, the remote device receives the request of the subscriber terminal and forms the related response. In the stage 6-2, the remote device detects whether the resource requested by the remote device is in a form that is suitable thereto. If not, the data is converted in the stage 6-4 to a more suitable form for the subscriber terminal. Otherwise, at 6-3, the remote device delivers the response to the serving node, wherefrom said remote device received the request in the stage 6-1. In the stage 6-5, the transmission system may change or convert the response delivered by the remote device. In the stage 6-6, the transmission system verifies, whether advertisements are to be added to the response delivered to the subscriber terminal. Should this be the case, in the stage 6-7, the desired advertisements are added to the response. In the stage 6-8, the transmission system delivers the response to the subscriber terminal.

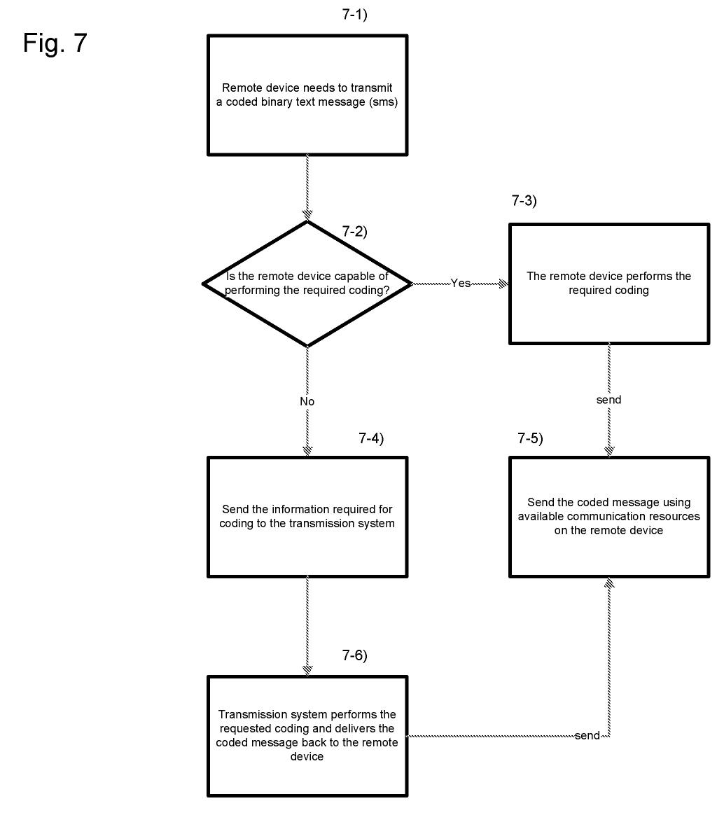

FIG. 7 discloses a control logic the purpose of which is to send a coded text message (e.g. SMS). At 7-1 the remote device prefers transmitting a coded binary text message. At 7-2 the remote device checks whether it is capable of performing the required coding. If not, at 7-4 the information required for coding are delivered to the transmission system that, at 7-6, performs the requested coding and delivers the coded message back to the remote device for sending. At 7-5 the remote device sends a coded message utilizing the communication resources thereof. In case the remote device is capable of autonomously executing the necessary coding, coding is performed at 7-3 whereafter the message is transmitted at 7-5.

The remote device may log in to the transmission system as a registered user or anonymously without the authentication information related to a registered user. In conjunction with logging-in, a new identifier (ID) is given to the remote device, with which can be pointed to the remote device in the transmission system. In case the device logs in to the system as a registered user, the remote device can be addressed with the permanent identifier of the user account. For anonymous remote device a connection-specific, changing (or “dynamic”/“non-static”) unique identifier is allocated. In that case, the remote device is addressed with a different identifier (ID) after every log-in occasion in the transmission system. After logging-in the authentication node directs to the remote device a communication node, whereto the remote device connects and finalizes the log-in relative to the transmission system.

It is assumed in the next example that the subscriber terminal is willing to use the resources of the remote device for which an identifier ID has been allocated.

The subscriber terminal sends to the transmission system a request, the URL (Uniform Resource Locator) of which is, for example, of form http://foo.com/path/ID/resource, where “foo.com” is the internet address, whereby the transmission system can be addressed in the Internet, “path” is identifying a path of the internal service of the transmission system, “ID” is the identifier allocated to the remote device upon log-in and resource depicts the resource requested from the remote device. In this example, a resource is requested from the transmission system according to HTTP protocol (Hypertext Transfer Protocol). Resource may be, for example, /tmp/file.bin, which refers to the file named file.bin located in a shared folder tmp.

The transmission system transmits information about the subscriber terminal and the resources said subscriber terminal has requested to the remote device identified by the identifier ID. The remote device verifies the validity of the received request and associated authorizations required. In case the resource requires the authentication of the subscriber terminal, and that has not yet been performed, the remote device sends the response comprising a request to the subscriber terminal to deliver authentication information bearing the sufficient authorizations (for example, the user name and the password). In case the asked resource exists, and there are no other obstacles for delivering it, the remote device makes the decision of converting data, requested in the resource, to a more suitable form for the subscriber terminal. This decision is made in view of the information informed by the subscriber terminal, wherein the information may include, for example, the resolution of the display, desired language, the address of the subscriber terminal in the access or service network and the used browser or other software features.

After such optional changes, the remote device delivers the response to the transmission system. The transmission system may change or convert the response delivered by the remote device, for example, according to the settings of the system, the information informed by the subscriber terminal itself and the settings of the used user account.

Optionally, both the remote device and the transmission system may convert the data to a different format depending on available coding algorithms (codecs), time, geographical location, bandwidth available for the data transfer, processor power and user's settings. Time instant may be noticed, for example, such that at night a picture with a better quality will be transmitted, or video in general or with enhanced quality, due to the generally reduced use of the transmission system and associated resources. The geographical location may be noticed, for example, such that video stream is delivered in different formats to subscriber terminals residing in different areas due to e.g. technical limitations, compatibility problems, or other factors. The available bandwidth for the data transmission may be taken into account, for example, such that with a narrow band the delivered pictures are reduced e.g. in size and/or coding quality so that the pictures could be transferred faster. Respectively, the format and quality of a video stream may be changed so as to correspond to the available data transfer (bit) rate.

Optionally, the transmission system may also prioritize selected communications according to user-related settings, a data type, guaranteed quality specifications, and/or the used service. Typically, that kind of prioritization is known as QoS (quality of service).

Optionally, the transmission system may reward a registered user for using the service by rendering virtual money to his/her virtual money account, whereby the number of the virtual money depends on the duration that the user has been logged in the system as a remote device.

Optionally, the remote device may transfer the used access network information to the transmission system (for example, cell id in GSM and UMTS networks). On the basis of such operation the transmission system is aware of the location of the remote device with adequate accuracy and may transfer to the remote device e.g. place-related news, commercial offers, advertisements, or other information.

Optionally, the information related to the registered user stored in the database of the transmission system may include settings about the provided quality of service such as the available data transfer band, the size limits relating to the data transfer, prioritization of the data transfer, permitted content types, the maximum resolution of the transferred pictures, a bit rate of sound and video contents as well as the number of the simultaneous logical data transfer channels.

Optionally, the transmission system may convert sound or video content received from the remote device into a streaming format by autonomously producing it (and the related control) from the content delivered by the remote device, such as a broadcast, according to RTSP (realtime streaming protocol). The transmission system may also operate as a streaming proxy, in case the remote device delivers the data in a format that is already suitable for streaming to the subscriber terminal.

Optionally, the transmission system may control the execution of the program code executed in the remote device. The program code may have been delivered to the remote device by the transmission system or some other way. For example, this enables the utilization of the remote device for distributed computing and for other functions, where several execution locations have to be controlled in a centralized manner. For example, different tests of distributed access and service networks, and tests of services, may be this kind of applications. The transmission system may, for instance, command a group of remote devices to simultaneously send email to a certain e-mail address. Such a procedure may enable detecting the transmission load in networks and e-mail systems.

Next, few preferred embodiments of the present invention are disclosed by way of example only. The following examples include the above-explained connection establishment and various stages related to the data transfer.

By way of example, the user may fetch with the mobile phone (subscriber terminal) his/her files from the remote device, which may include, for example, a computer connected to the network and located at home. The user may, for example, view the digital photos located at the home computer such that the photos are converted to a suitable form in accordance with the display of the mobile phone, or the user may download digital content, such as music, pictures or videos, to the mobile phone.

By way of example, the user may also transfer files or another data from the mobile phone to the remote device, which may be a computer that is located at home or at the workplace among other options. The user may, for instance, easily transfer the photos taken with the camera of the mobile phone to the home computer or respectively, transfer the other data such as different back-up copies from the mobile phone to the home computer.

By way of example, the remote device may also be a mobile terminal (e.g. cell phone) or a PDA capable of executing an application that is compatible with the transmission system. Then the device may act as a remote device and a subscriber terminal as the data may be fetched from the device and the device is also capable of fetching data from other remote devices via data transmission capitalizing either an application or a browser already present in the device.

By way of example, the remote device may also inform the transmission system about new shared resources or other changes. If the remote device is or comprises a mobile terminal, it may also send a link (URL, etc.) to the device of another user as a text or multimedia message. If a text message is exploited, it may include readable text or a coded service message. The related coding may be performed by the remote device, or the remote device may provide the message to the transmission system for coding and subsequently transmit the coded message retrieved from the transmission system forward.

By way of example, an application installed to the mobile terminal may enable functioning of the terminal as a remote device, and it may add itself to the menus of the terminal such that new resources may be advertised via the communication menus and phonebook of the terminal.

By way of example a remote device that can localize itself utilizing an internal, SIM-based or external satellite navigation (e.g. GPS) or location information and technology provided by the access network, may transmit the location information thereof to the transmission system. The transmission system may forward this location information to a number of selected remote devices or subscriber terminals, or provide the information to other systems via an interface (2-10) for external applications.

By way of example, the Internet search engines may index the resources shared by the remote device, including e.g. files. Accordingly, the files may be found via the Internet search engines. This benefit is enabled by the direct URL (web address) allocated to each remote device and resource thereof via the transmission system.

By way of example, the user may correspondingly remotely control programs that are executed by the computer located at home, or even control devices connected to the aforesaid computer. The user may, for example, administrate the web camera connected to the computer and receive the camera pictures to his/her subscriber terminal such as a mobile phone.

By way of example, the user may also, if he/she desires, sell his/her own content to the other users by adding, to a shareable resource located in the remote device, information, which defines the price for the resource in the transmission system. To the user, who is eager to use the aforementioned chargeable resource via the transmission system, is then presented the price of the requested resource and the invoicing mechanism used for charging. Optionally, the invoicing mechanism may be a ‘digiraha’(digital money) invoicing product offered by different credit institutions, WAP or SMS invoicing used by the mobile phone operators, or another digital money that is in use for this purpose.

By way of example, focused advertisements may be added into the user interface and content presented via the browser of the mobile phone (subscriber terminal). These advertisements may be targeted according to the user-related information optionally disclosed by the user itself or being technically obtained. The user may have told his/her hobbies, gender, age or other information while registering to the system. In addition, the system obtains information of the user's terminal station (subscriber terminal), its features and the user's addresses in the access and the service network (for example, IP address). Advertisements may be focused also on the basis of the processed content. For example, when the user fetches music from the remote device, music-related advertisements may be offered, and respectively, developing and processing services may be suggested while viewing digital photos. An advertisement may act as a link to an advertised service. The transmission system may deposit a part of the revenue obtained from an advertisement to that registered user's account, whose remote device has provided the content in connection of which the advertisement-related revenue has accrued.

Further optionally, the transmission system may index files located in the remote device and other resources, and provide different search services that enable information searches in every remote device connected to the system provided that said remote devices have completely or at least partly allowed such functionality.

It will be apparent to those skilled in the art that the examples related to the preferred embodiments of this invention described above are not meant to limit but merely illustrate the invention. Although, for instance, HTTP protocol has been used as an example, it is apparent that the other protocols may be used as well, and the basic idea of the present invention may be implemented with several different ways. Thus the invention and the embodiments thereof are not restricted to the above described examples, and the embodiments may vary within the scope of the patent claims.

1-18. (canceled)

19. A method for data transfer between a subscriber terminal (1-1) and a remote device (1-2), characterized in that a transmission system (1-3) is used in the data transfer, and that the transmission system (1-3) can change or convert (3-16, 3-17, 3-18) the data it delivers, wherein each remote device is provided with a unique URL (Uniform Resource Locator) enabling addressing the device in the transmission system (1-3), and that the services, which the transmission system (1-3) provides to the subscriber terminal (1-1), are available for use via an Internet browser executed in the subscriber terminal, and that the establishment of the data transfer connection and transferring data comprises:
the remote device (1-2) establishes a connection (3-1) to the transmission system (1-3);
the transmission system (1-3) allocates an unique identifier (3-5), which is a permanent, unique identifier relative to the remote device of a registered user, and a dynamic, unique identifier relative to an anonymous remote device, said identifier being included in the unique URL by which the remote device (1-2) can be addressed in the transmission system (1-3);
the subscriber terminal (1-1) sends to the transmission system (1-3) a request (3-7) that is directed to the remote device (1-2) identified with the unique identifier;
the transmission system (1-3) transmits (3-8, 3-13, 3-14) the aforesaid request (3-7) to the remote device (1-2) identified with the aforesaid identifier;
the remote device (1-2) receives the request (3-14), verifies the authorization of the subscriber terminal (1-1) to the requested resource and sends to the transmission system (1-3) a response (3-15) to the request (3-7); and
the transmission system (1-3) delivers the response (3-15) to the subscriber terminal (1-1).

20. A method according to claim 19, characterized in that the remote device (1-2) is located in an access network, where said remote device (1-2) may be addressed with an identifier allocated to said remote device (1-2) via the transmission system (1-3), and that the subscriber terminal (1-1) is located in an access network, and that the transmission system (1-3) is located either in an access network or a service network.

21. A method according to claim 19, characterized in that the transmission system (1-3) indexes the shared resources of the connected remote devices (1-2), and that the transmission system (1-3) has a search functionality that can be used to search for the resources.

22. A method according to claim 19, characterized in that the data delivered by the transmission system (1-3) to the subscriber terminal (1-1) can be changed (3-17, 3-18) in the transmission system (1-3) according to the information informed by the subscriber terminal (1-1) about itself.

23. A method according to claim 19, characterized in that the transmission system (1-3) provides information about the subscriber terminal (1-1) sending the request (3-7), said information being informed by said subscriber terminal (1-1) itself, to the remote device (1-2) on the basis of which the remote device (1-2) is enabled to convert data into a suitable form for the subscriber terminal (1-1).

24. A method according to claim 19, characterized in that in the database (2-9) of the transmission system (1-3) comprises data records directed to the registered users, wherein said data records maintain among other information a virtual money account, and that said account can be used in at least one way selected from the group consisting of:
the transmission system (1-3) performs refunds to the account; and
the subscriber terminal (1-1) can spend virtual money present on that account, if transmission system (1-3) has identified the user represented by the subscriber terminal (1-1).

25. A method according to claim 19, characterized in that the user registered in the transmission system (1-3) is possible to exchange virtual money registered in the transmission system (1-3) to real money, goods or a refund in the way, which is agreed on separately, case by case.

26. A method according to claim 19, characterized in that the transmission system (1-3) is enabled to produce the charging information (3-19) related to the transferred data and enter as income a part of the charge to the registered user represented by the remote device (1-2), and that the aforesaid charging process comprises one or more steps selected from the group consisting of:
the remote device (1-2) delivers the response (3-15) including the information about the charging criteria to the subscriber terminal (1-1) via the transmission system (1-3);
in case the remote device (1-2) requires a charge for the data, the transmission system (1-3) verifies from the subscriber terminal (1-1) that the user is willing to pay accordingly;
the transmission system (1-3) adds to the response (3-16) information used for charging (3-19) as needed by the operator, the service provider, or some other corresponding instance; and
the transmission system (1-3) enters as income a part of the charge as virtual money to the remote device (1-2) in case said remote device (1-2) represents a registered user of the transmission system (1-3).

27. A method according to claim 19, characterized in that the transmission system (1-3) profiles the subscriber terminal (1-1) on the basis of the information concerning and given by it and address information, and delivers focused advertisements (3-18) in connection with the response (3-16, 3-17).

28. A method according to claim 27, characterized in that a part of the income produced by the advertisements (3-18) delivered alongside the response (3-15, 3-16) that is transmitted from the remote device (1-2) to the subscriber terminal (1-1), may be entered as income as virtual money to the remote device (1-2) in case said remote device (1-2) represents a user registered in the transmission system (1-3).

29. A method according to claim 19, characterized in that the transmission system (1-3) comprises several distributed components, and that said transmission system (1-3) controls the logics and communication between the components, wherein said components are optionally geographically separated.

30. A method according to claim 19, characterized in that either, the connection between the transmission system (1-3) and the remote device (1-2) is encrypted, or the connection between the transmission system (1-3) and the subscriber terminal (1-1) is encrypted, or optionally both the aforementioned connections are encrypted.

31. A method according to claim 19, characterized in that the remote device (1-2) localizes itself by an internal, SIM-card located, or external satellite navigation receiver, or by utilizing the positioning technology provided by the access network, and forwards the location information to the transmission system (1-3).

32. A method according to claim 19, characterized in that the remote device, while transmitting a coded text message, first delivers a message to the transmission system for coding and subsequently transmits a coded message received from the transmission system forward (FIG. 7).

33. A transmission system for enabling data transfer between a subscriber terminal and a remote device, characterized in that said transmission system comprises control logic to control the creation of the data transfer connection and the data transfer between the subscriber terminal and the remote device, and in that said control logic comprises:
a first logic configured to define an applicable communications node for the remote device and to provide the remote device with a unique URL (Uniform Resource Locator) to enable addressing the remote device in the transmission system by the subscriber terminal via an Internet browser, wherein a permanent, unique URL (Uniform Resource Locator) is provided relative to the remote device of a registered user and a non-permanent, unique URL is provided relative to an anonymous remote device; and
a second logic configured to deliver a service request sent by the subscriber terminal to the remote device.

34. The transmission system according to claim 33, further comprising a third logic configured to present the response of the remote device in a form suitable for the subscriber terminal.

35. The transmission system according to claim 34, further comprising a third logic configured to present the response of the remote device in a form suitable for the subscriber terminal.

36. A method according to claim 20, characterized in that the transmission system (1-3) indexes the shared resources of the connected remote devices (1-2), and that the transmission system (1-3) has a search functionality that can be used to search for the resources.

37. A method according to claim 20, characterized in that the data delivered by the transmission system (1-3) to the subscriber terminal (1-1) can be changed (3-17, 3-18) in the transmission system (1-3) according to the information informed by the subscriber terminal (1-1) about itself.

38. A method according to claim 21, characterized in that the data delivered by the transmission system (1-3) to the subscriber terminal (1-1) can be changed (3-17, 3-18) in the transmission system (1-3) according to the information informed by the subscriber terminal (1-1) about itself.
